(19) United States
(12) Patent Application Publication
(10) Pub. No.: US 2020/0305359 A1
(43) Pub. Date: Oct. 1, 2020

(54) LEAF AND YARD DEBRIS COLLECTION AND TRANSPORTATION DEVICE

(71) Applicant: Gwendolyn Oakes, Landing, NJ (US)

(72) Inventor: Gwendolyn Oakes, Landing, NJ (US)

(21) Appl. No.: 16/825,477

(22) Filed: Mar. 20, 2020

Related U.S. Application Data
(60) Provisional application No. 62/823,551, filed on Mar. 25, 2019.

(51) Int. Cl. A01G 20/43; A01D 7/00

(52) U.S. Cl. CPC A01G 20/43; A01D 7/00

(57) ABSTRACT

The leaf and yard debris collection and transportation device includes two lightweight rakes with cushioned handles, joined in an X-shape, thereby allowing the rake end of each pole to open and close with respect to the other with a scissor motion. To use the leaf and yard debris collection and transportation device, the user pulls the cushioned handles apart, opening the rake ends over a pile of leaves or yard debris, lowers the rake ends onto the pile and applies slight pressure with the rake ends, then pushes the handles towards each other, causing the rake ends to close, collecting the leaves and/or debris between them. The user can then move the collected leaves and/or debris to another location, such as a trash bag or green recycling bin, and pull the handles apart again, opening the rake ends and releasing the leaves and/or debris into the desired location.

### CROSS-REFERENCE TO RELATED APPLICATION

The present application is related to and claims priority from prior provisional application Ser. No. 62/823,551, filed Mar. 25, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of landscaping devices, particularly lawn and garden tools. More specifically, the invention is yard too that allows a user to collect, secure, and transport leaves and other garden debris with minimal exertion while remaining in an upright standing position, without putting strain on the back, neck, legs, or arms.

### 2. DESCRIPTION OF THE RELATED ART

Yards require maintenance, such as planting, weeding, mowing, digging, and raking. Multiple lawn and garden tools are often needed to perform these tasks, and many of the available tools are heavy and may put excessive stress on the user's upper body and back, especially after repeated use. Many also require the user to perform repetitive actions, including repeatedly bending over, and such repetitive actions can lead to pain and even injury.

Ideally, a leaf and yard debris collection and transportation device should provide a way for a user to collect, secure, and transport leaves and other garden debris with minimal exertion while remaining in an upright standing position, without putting strain on the back, neck, legs, or arms and, yet would operate reliably and be manufactured at a modest expense. Thus, a need exists for a reliable leaf and yard debris collection and transportation device to avoid the above-mentioned problems.

### BRIEF SUMMARY OF THE INVENTION

In view of the foregoing disadvantages inherent in the known lawn and garden tool art, the present invention provides a novel leaf and yard debris collection and transportation device. The general purpose of the present invention, which will be described subsequently in greater detail is to provide a way for a user to collect, secure, and transport leaves and other garden debris with minimal exertion while remaining in an upright standing position, without putting strain on the user's back, neck, legs, or arms.

The leaf and yard debris collection and transportation device has a scissor-type design that makes it possible to quickly and easily gather leaves and/or garden debris together and transport it to a desired location. The leaf and yard debris collection and transportation device includes two lightweight rakes with cushioned handles, joined in an X-shape via a bolt and nut, allowing the rake end of each pole to open and close with respect to the other with a scissor motion.

To use the leaf and yard debris collection and transportation device, the user would pull the cushioned handles apart, opening the rake ends over a pile of leaves or yard debris, lower the rake ends onto the pile of leaves or yard debris and apply slight pressure to the pile with the rake ends, then push the handles towards each other, causing the rake ends to close, collecting the leaves and/or debris between them. The user can then move the collected leaves and/or debris to another location, such as a trash bag or green recycling bin, and pull the handles apart again, opening the rake ends and releasing the leaves and/or debris into the desired location.

The leaf and yard debris collection and transportation device can be constructed using plastic, metal, or other suitable lightweight materials. The exact size, measurements, construction, and design specifics may vary, including but not limited to the length, material, and diameter of the rake poles, the size, material, and design of the rake portions, the size, material, and style of the handles, and the exact attachment method used to achieve the X-shape connection between the two rakes.

The present invention holds significant improvements and serves as a leaf and yard debris collection and transportation device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a leaf and yard debris collection and transportation device, constructed and operative according to the teachings of the present invention.

FIG. 1 shows a perspective view illustrating a leaf and yard debris collection and transportation device according to an embodiment of the presently claimed invention.

FIG. 2 is a perspective view illustrating a leaf and yard debris collection and transportation device in an open position, according to an embodiment of the presently claimed invention.

FIG. 3 is a perspective view illustrating leaf and yard debris collection and transportation device closed around a pile of leaves, according to an embodiment of the presently claimed invention.

FIG. 4 is a perspective view illustrating leaf and yard debris collection and transportation device transporting a pile of leaves, according to an embodiment of the presently claimed invention.

FIG. 5 is a perspective view illustrating a leaf and yard debris collection and transportation device in a closed, empty position, according to an embodiment of the presently claimed invention.

The various embodiments of the present invention will hereinafter be described in conjunction with the appended drawings, wherein like designations denote like elements.

### DETAILED DESCRIPTION

As discussed above, embodiments of the present invention relate to a lawn and garden tool, and more particularly to a leaf and yard debris collection and transportation device as used to collect, secure, and transport leaves and other garden debris with minimal exertion while remaining in an upright standing position, without putting strain on the user's back, neck, legs, or arms.

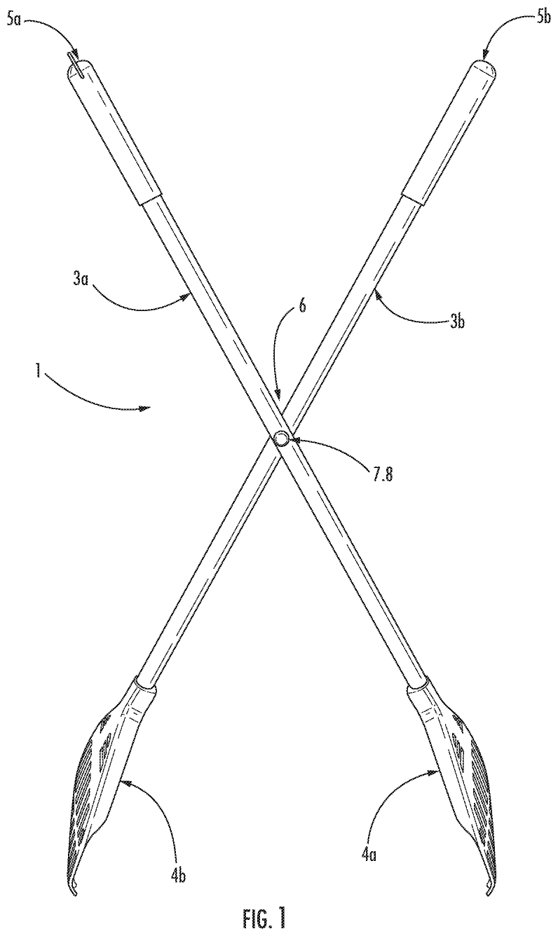

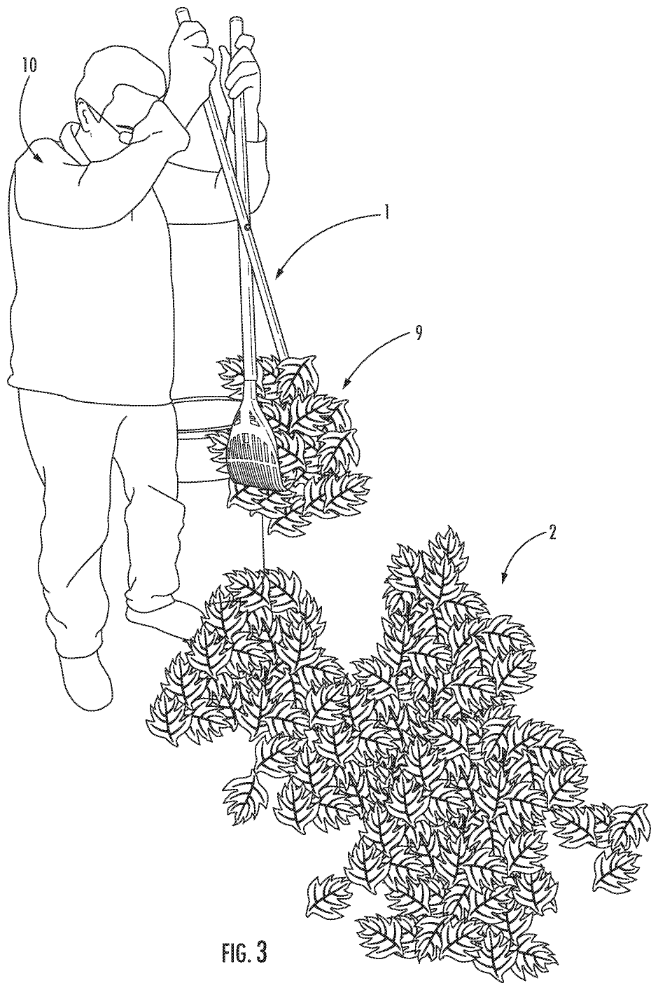

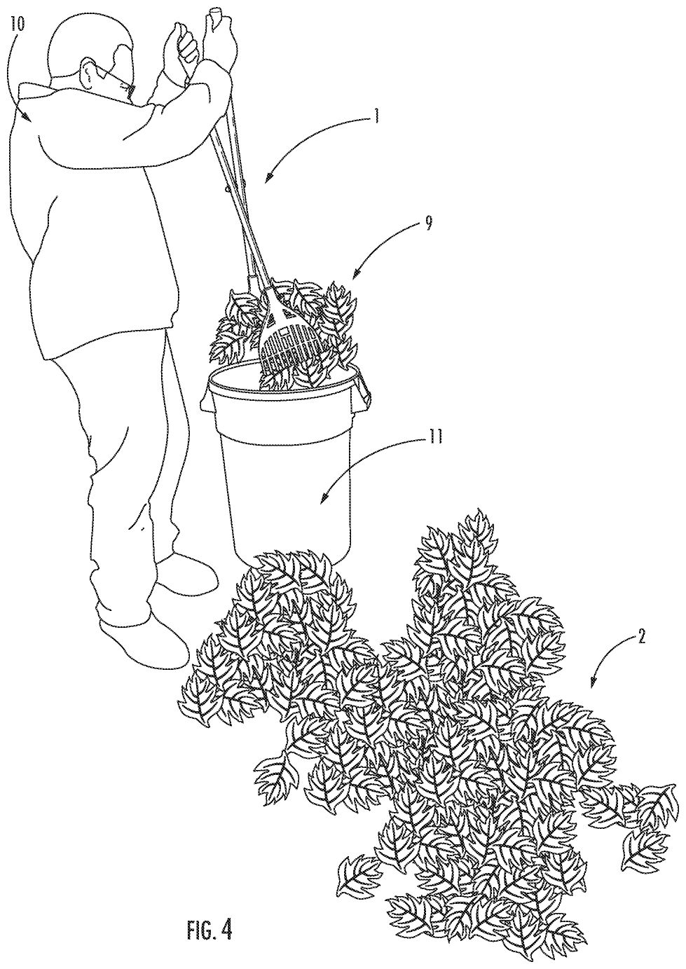

Referring to the drawings by numerals of reference there is shown in FIGS. 1-5, a leaf and yard debris collection and transportation device 1 with a scissor-type design that makes it possible to quickly and easily gather leaves and/or garden debris 2 together and transport it to a desired location. The leaf and yard debris collection and transportation device 1 includes two lightweight poles 3a, 3b. Each pole 3a, 3b has a lightweight rake portion 4a, 4b at one end, and a cushioned handle 5a, 5b at the other end. The poles 3a, 3b, rake portions, 4a, 4b, and handles 5a, 5b, may be formed of wood, plastic, metal, or any other suitable lightweight material. The rake portions 4a, 4b are preferably formed of plastic. The handles 5a, 5b are preferably cushioned with foam.

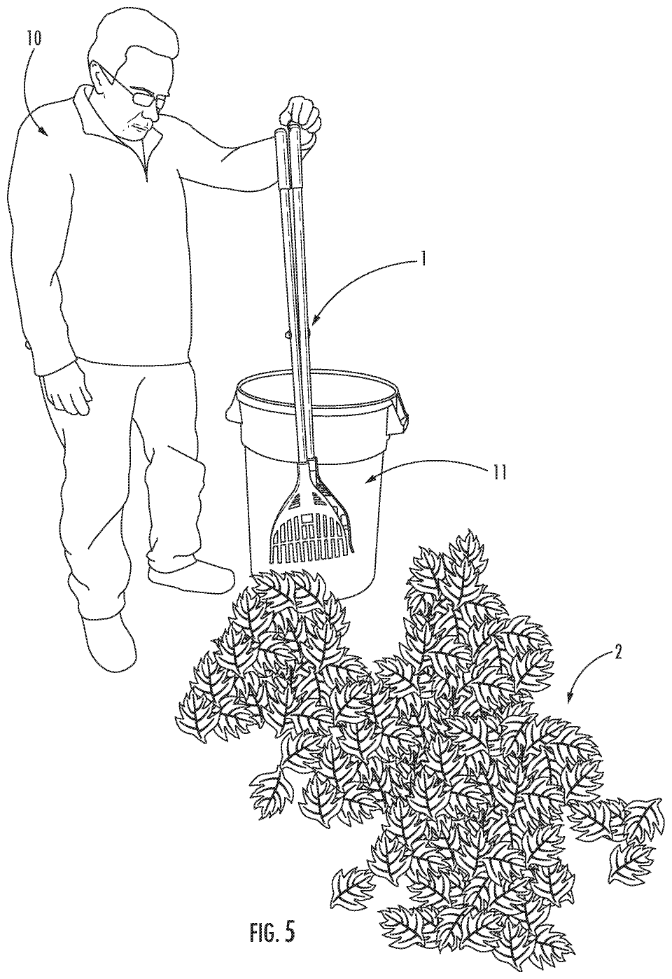

The two poles 3a, 3b are joined towards the center of each pole 3a, 3b in an X-shape 6. The poles 3a, 3b are preferably joined via a bolt 7 and nut 8, allowing the rake end 4a, 4b of each pole 3a, 3b to open and close with respect to the other with a scissor motion. As shown in FIG. 1, when in an open position, the first handle 5a is located above the second rake end 4b and is hinged apart from the second handle 5b, located above the first rake end 4a, at the X-joint 6, creating an x-shape. As shown in FIG. 5, when in a closed position, the first handle 5a is adjacent to the second handle 5b, and the second rake end 4b is adjacent to the first rake end 4a, forming a straight line and compact shape for ease of storage.

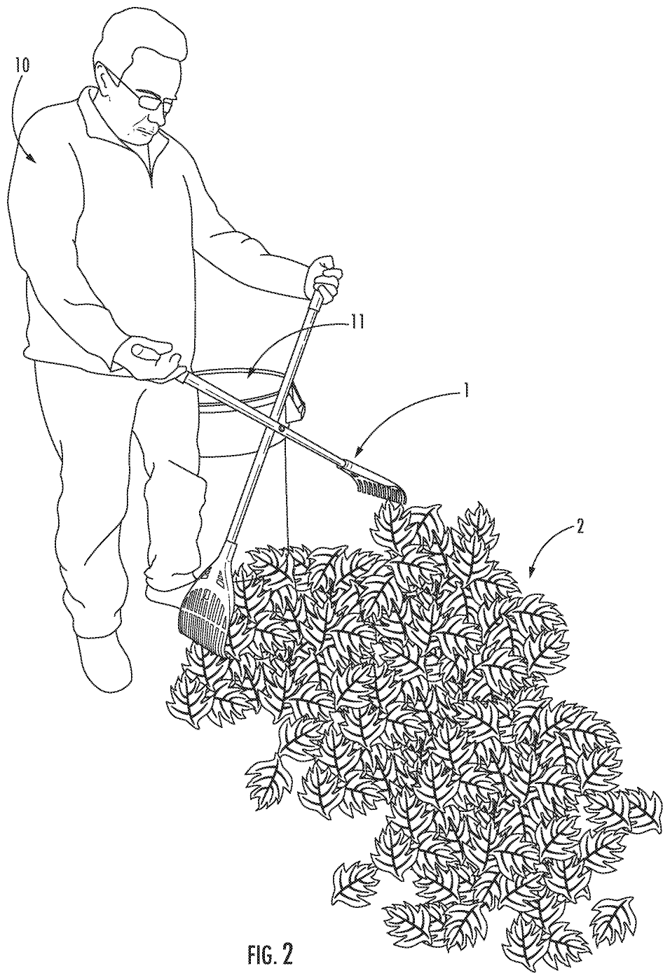

As shown in FIGS. 2-5, to use the leaf and yard debris collection and transportation device 1, the user 10 pulls the cushioned handles 5a, 5b apart, opening the rake ends 4a, 4b over a pile of leaves or yard debris 2. The user 10 next lowers the rake ends 4a, 4b onto the pile of leaves or yard debris 2 and applies slight pressure to the pile 2 with the rake ends 4a, 4b. Next the user 10 pushes the handles 5a, 5b towards each other, causing the rake ends 4a, 4b to close, collecting a portion of the leaves and/or debris 9 between the rake ends 4a, 4b. The user 10 can then move the collected leaves and/or debris 9 to another location, such as a trash bag or green recycling bin 11, and pull the handles 5a, 5b apart again, opening the rake ends 4a, 4b and releasing the collected leaves and/or debris 9 into the desired location.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A leaf and yard debris collection and transportation device comprising:
(a) a first pole with
(i) a first rake portion at a first end; and
(ii) a first handle at an opposing second end;
(b) a second pole with
(i) a second rake portion at a first end; and
(ii) a second handle at an opposing second end; and
(c) an X-joint,
wherein the first pole is operably connected to the second pole via the X-joint so that first pole and the second pole form an X-shape when the first handle is pulled away from the second handle.

2. The leaf and yard debris collection and transportation device according to claim 1, wherein the X-joint includes a nut and a bolt.

3. The leaf and yard debris collection and transportation device according to claim 1, wherein the first pole and the second pole are formed of a plastic material.

4. The leaf and yard debris collection and transportation device according to claim 1, wherein the first pole and the second pole are formed of wood.

5. The leaf and yard debris collection and transportation device according to claim 1, wherein the first pole and the second pole are formed of a lightweight metal material.

6. The leaf and yard debris collection and transportation device according to claim 1, wherein the first rake portion and the second rake portion are formed of a plastic material.

7. The leaf and yard debris collection and transportation device according to claim 1, wherein the first handle and the second handle both include a cushioned grip.

8. The leaf and yard debris collection and transportation device according to claim 7, wherein the cushioned grip of the first handle and the cushioned grip of the second handle are formed of foam.

9. A method of using the leaf and yard debris collection and transportation device according to claim 1, the method comprising the steps of:
(1) providing the leaf and yard debris collection and transportation device according to claim 1;
(2) pulling the first handle and the second handle apart, thereby opening the first rake portion away from the second rake portion;
(3) lowering the first rake portion and the second rake portion over a pile of garden debris;
(4) pushing the first handle towards the second handle, thereby closing the first rake portion towards the second rake portion, trapping at least one portion of the garden debris between the first rake portion and the second rake portion;
(5) lifting the leaf and yard debris collection and transportation device away from the garden debris;
(6) moving the leaf and yard debris collection and transportation device to a desired location; and
(7) pulling the first handle away from the second handle, thereby opening the first rake portion away from the second rake portion, emptying the at least portion of garden debris onto the desired location.

10. A leaf and yard debris collection and transportation device comprising:
(a) a first pole with
(i) a first rake portion at a first end; and
(ii) a first handle with a cushioned grip at an opposing second end;
(b) a second pole with
(i) a second rake portion at a first end; and
(ii) a second handle with a cushioned grip at an opposing second end; and
(c) an X-joint including
(i) a nut; and
(ii) a bolt,
wherein the first pole is operably connected to the second pole via the X-joint so that first pole and the second pole form an X-shape when the first handle is pulled away from the second handle,
wherein the first pole and the second pole are formed of a material selected from a group consisting of plastic, wood, and metal,
wherein the first rake portion and the second rake portion are formed of a plastic material, and
wherein the cushioned grip of the first handle and the cushioned grip of the second handle are formed of foam.
